(19) United States
(12) Patent Application Publication
(10) Pub. No.: US 2005/0105580 A1
(43) Pub. Date: May 19, 2005

(54) Apparatus for and method of series operation of DC microdischarge stages in a tube geometry for microlaser applications

(76) Inventors: Konstantinos P. Giapis, Pasadena, CA (US); R. Mohan Sankaran, Pasadena, CA (US)

Correspondence Address: Daniel L. Dawes;MYERS DAWES ANDRAS & SHERMAN LLP, Suite 1150, 19900 MacArthur Boulevard, Irvine, CA, 92612, US

(21) Appl. No.: 10/956,811

(22) Filed: Oct. 1, 2004

Related U.S. Application Data
(60) Provisional application No. 60/519,714, filed on Nov. 13, 2003.

(51) Int. Cl. H01S 3/22

(52) U.S. Cl. 372/57; 372/58

(57) ABSTRACT

A method of operation and an apparatus for providing excimer radiation is performed in and comprised of a plurality of microdischarge stages respectively. Each stage is comprised of a cathode element and anode-like element through which elements a selected gas flows. The microdischarge stages of the plurality are serially communicated with each other such that the gas flows in succession through each stage of the plurality. A power supply is coupled to each stage for providing a correspondingly selected plasma voltage to each stage to initiate and/or maintain an excimer plasma within each stage.

### RELATED APPLICATIONS

The present application is related to U.S. Provisional Patent Application Ser. No. 60/519,714, filed on Nov. 13, 2003, which is incorporated herein by reference and to which priority is claimed pursuant to 35 USC 119.

### BACKGROUND OF THE INVENTION

1. Field of the Invention

The invention relates to the field of the fabrication and design of an excimer microlaser using high-pressure capillary microdischarges in static and flow geometries using high pressure plasma microjets with an extended plasma volume as a lasing medium.

2. Description of the Prior Art

Microhollow planar cathode discharges (MHCDs) or microdischarges are direct-current (DC) high-pressure discharges formed in a thin three layer, metal-dielectric-metal structure, each of which are about 100 μm in thickness.

While various electrode geometries have been explored to take advantage of the hollow cathode, in general, a thin metal plate less than 200 μm thick with an aperture between 100-700 μm in diameter serves as the cathode. The pressure at which the discharge can be operated has been shown to depend inversely on the hole diameter with atmospheric-pressure operation requiring diameters less than 250 μm in rare gases and less than 100 μm in air. Devices in most of these cases consist of a metal-dielectric-metal structure with a hole through all three layers. Recently, the structure has also been expanded to multilayer structures in order to increase the active length of the device. Lifetime and stability of microdischarges in this configuration are limited by the dielectric, often a polymer, which can fail due to deposition of sputtered cathode material and thermal decomposition. Because of these concerns, discharge currents are often kept below 7 mA to extend the lifetime of devices. Multilayer structures also suffer from complex fabrication steps with only small increases in the total length of the device.

Hollow cathode microdischarges in the prior art are stable, high-pressure discharges formed between a cathode with a hole and an anode of arbitrary shape. It has been previously found experimentally that it is necessary to reduce the cathode hole diameter to near 100 μm to allow operation at atmospheric pressure in rare gases such as neon, argon, and xenon. The electrode geometry usually consists of a sandwich structure of two metal plates on either side of a thin dielectric spacer. Discharges are struck in the confined volume between the metal electrodes in a direct current mode with similar voltages used for conventional glow discharges, but much larger current densities.

The increase in the number of ionization processes is caused by the Pendel effect, which is the oscillatory motion of electrons in the radial electric field created by the hollow cathode. Optical studies in rare gases have confirmed the presence of a large concentration of high energy electrons by the emission of excimer radiation and other highly excited states. An excimer, which is an abbreviated label for “excited dimer”, is a gas molecule that emits light or radiation when stimulated by an electric field. This effect can be used to produce a powerful laser. These properties warrant the use of microdicscharges in materials processing where the production of reactive radicals at high pressures is often required. We have recently reported one such application where Ar/CF₄ microdischarges were used to etch silicon.

Tubes have been simultaneously used in the prior art as the gas inlet and cathode, but with openings of the order of 0.4-2 mm, which are much larger than those found in hollow cathode microdischarges. For this reason, the discharges were operated at lower pressures (p<1 Torr) and used radio frequency power which requires complicated impedance matching networks. Furthermore, in some cases, although operation was achieved at atmospheric pressures, the discharge was found to form on the surface of the electrodes and did not operate as a hollow cathode.

Further, such hollow cathode microdischarges have a flat or disk geometry in which the plasma is confined to the small disk-shaped space between opposing dielectric planes. This geometry excludes its usage in many applications where a projecting plasma onto a material substrate is needed. What is needed is some kind of method and apparatus having a geometry whereby hollow cathode microdischarges can be effectively and practically extended to interact with surfaces.

The microhollow cathode discharges are normally operated using a cathode with a pin-hole of approximately 100 μm in diameter and an arbitrarily shaped anode. Stable high-pressure operation above atmospheric has been achieved in a variety of rare gases and rare gas halides. Optical studies have shown the presence of a large concentration of high-energy electrons. Because of these two characteristics, microdischarges have attracted interest as a source of excimers, i.e. molecular dimer complexes, which source requires three-body collisions of excited atomic states. Excimer emission has been observed in microdischarges of Ne³, Ar⁴, Xe⁴ ArF⁵ XeCl⁶ and XeI⁷.

### BRIEF SUMMARY OF THE INVENTION

The invention is defined in the illustrated embodiment as an apparatus for providing excimer radiation comprised of a plurality of microdischarge stages. Each stage is comprised of a cathode element and anode-like element through which elements a selected gas flows. The microdischarge stages of the plurality are serially communicated with each other such that the gas flows in succession through each stage of the plurality. A power supply is coupled to each stage for providing a correspondingly selected plasma voltage to each stage to initiate and/or maintain an excimer plasma within each stage.

In one embodiment, the plurality of microdischarge stages comprises an alternating planar array of metal and insulating layers through which a common plasma cavity is defined for the flow of gas. The metal layers are coupled to the power supply and configured as an alternating sequence of cathodes and anodes. The alternating sequence of cathodes and anodes can either be configured to provide an initial cathode and a final cathode in the sequence at the ends of the plurality of microdischarge stages or to provide an initial anode and a final anode in the sequence at the ends of the plurality of microdischarge stages.

In another embodiment, the plurality of microdischarge stages comprises an alternating sequence of cathode tubes and anodes. The anodes may be configured either as anode grids or anode apertures. However, the scope of the invention contemplates any form of anodes which may be now known or later devised.

The apparatus further comprises a resistance ladder having a plurality of nodes coupled to the power supply and at selected nodes of the resistance ladder to the sequence of cathode tubes.

In still another embodiment, the plurality of microdischarge stages comprises a sequence of cathode tubes and a single terminating anode at the end of the sequence of cathode tubes. Each cathode tube downstream in the sequence as defined by the flow of gas serves as the anode for the cathode tube upstream in the sequence.

The invention also contemplates a method of operating the above apparatus, including utilizing the plasma created in a microlaser.

While the apparatus and method has or will be described for the sake of grammatical fluidity with functional explanations, it is to be expressly understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112 are to be accorded full statutory equivalents under 35 USC 112. The invention can be better visualized by turning now to the following drawings wherein like elements are referenced by like numerals.

### BRIEF DESCRIPTION OF THE DRAWINGS

FIGS. 1a and 1b are diagrammatic side cross-sectional views of two embodiments of a series stacked assembly of planar microdischarge devices.

FIG. 2 is a diagram of a single stage tube microdischarge device.

FIGS. 3a and 3b are diagrams of two embodiments of a series stacked assembly of two tube microdischarge devices of the type depicted in FIG. 2.

FIG. 4 is a diagram of a series stacked assembly of three tube microdischarge devices of the type depicted in FIG. 2.

The invention and its various embodiments can now be better understood by turning to the following detailed description of the preferred embodiments which are presented as illustrated examples of the invention defined in the claims. It is expressly understood that the invention as defined by the claims may be broader than the illustrated embodiments described below.

### DETAILED DESCRIPTION OF THE PREFERRED EMBODIMENTS

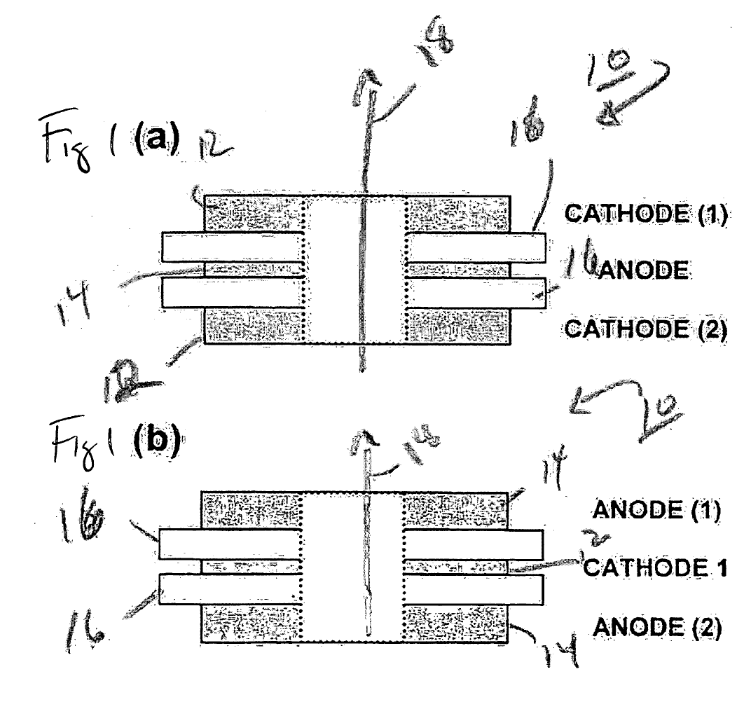

The excimer intensity for a selected gas has been shown to vary with pressure and input power. However, larger amplification of the optical output is required for making an excimer microlaser. The simplest way to increase emission intensity while operating stably is to increase the plasma volume as, for example, when striking multiple discharges in series. In one embodiment, structures have been made with alternating planar layers of metals and insulating dielectrics as shown in FIGS. 1a and 1b, which diagrammatically depict planar microdischarge assemblies, generally denoted by reference numeral 10, with plasma flow in the direction of arrow 18 stacked in series in a planar electrode geometry with three metal layers serving as electrodes 12 and 14 of 250 μm, 100 μm, and 250 μm thickness respectively, separated by two dielectric layers 16 of 200 μm thickness. The discharges assemblies 10 are operated in two different configurations. FIG. 1a uses the outside electrodes as cathodes 12 and the center electrode as the anode 14. FIG. 1b uses outside electrodes as anodes 14 and the center electrodes as the cathode 12.

By operating each repeating three-layer microdischarge 10 similar to a single tube microdischarge device, the intensity of excimer emission has been shown to increase with the total length of the assembly or number of discharge stages, each of which are defined as a single anode-cathode combination 12, 14. In the case of FIGS. 1a and 1b, two microdischarge stages 12, 14 are operated in series by using a five layer structure of metals and dielectrics resulting in a doubling of the excimer intensity. While initial results are promising, obtaining the discharge lengths required for lasing requires several hundreds of stacked stages 12, 14. Even if fabrication of such assemblies were straightforward, one would run into difficulties associated with thermal management and contamination from sputtering at the metal-to-dielectric interface. Furthermore, in the case of the configuration used in FIG. 1a, the plasma does not completely fill the cavity in the assembly 10, requiring more than one power supply to generate the same current in each discharge stage.

An alternative technique to increasing the discharge length of assembly 10 is to extend the electrode geometry to a longitudinally extending tube. As demonstrated previously in Giapis et. al., U.S. Published Patent Applications 20040116752 (2004) and 20020171367 (2002) which are incorporated herein by reference, discharges in a hollow tube can be operated similarly to the metal foils used in planar microdischarges. Expanding the discharge in a capillary tube offers a superior solution to increasing discharge volume as compared to stacking together multiple planar discharges as diagrammatically shown in FIGS. 1a and 1b.

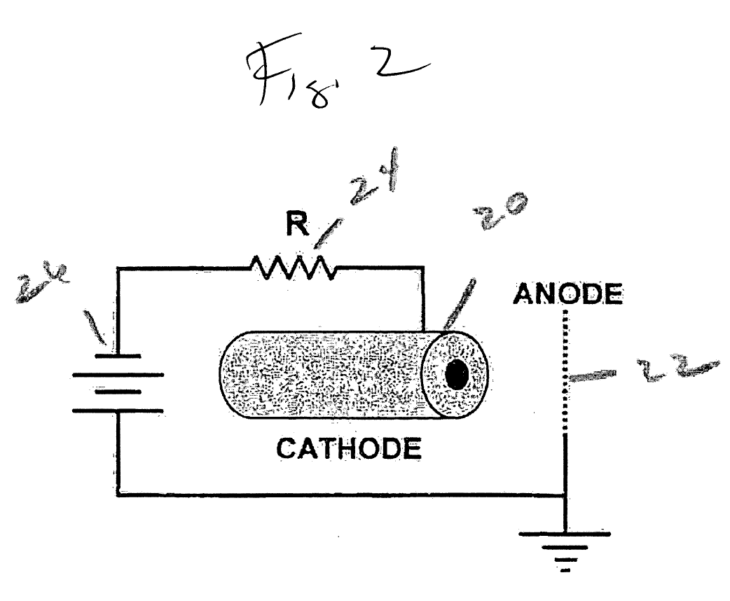

Furthermore, this alternative technique extends the plasma primarily in the cathode region 12 where the electron energy is the highest. In comparison to the planar device in FIG. 1a, a tube of 5 mm length could increase the length of the cathode and the plasma volume by 20-30 times. We have recently performed experiments in argon and helium plasma tubes to study how discharges could fill these tubes beginning with a single tube set-up shown in FIG. 2, which is a schematic depiction of a microdischarge device 10 using a single cathode tube 20 and anode grid 22. The tube 20 is a stainless steel capillary tube (0.0625″).D., 0.007″ I.D.). A current-limiting resistor 24 is placed in series with power supply 26 (R=25 kΩ). In this configuration, the discharge length is increased by changing the gas pressure and input power.

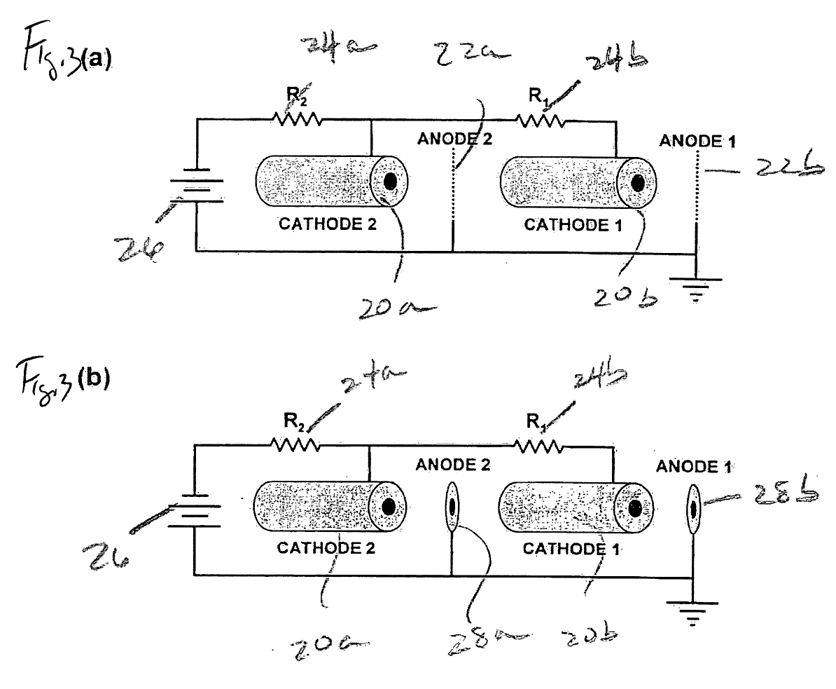

One means of increasing the plasma volume is the stacking and alignment of multiple tubes and screen combinations 20, 22. In FIGS. 3a and 3b, two possible configurations for series operation are diagrammatically shown, where multiple discharge stages in metal capillary tubes 20a and 20b are placed in series in alternating cathode/anode configuration with (a) anode apertures 28a, 28b and (b) anode grids 22a, 22b. Tubes 20a and 20b are in all cases stainless steel capillary tubes (0.0625″ O.D., 0.007″ I.D., 4 mm length). Tubes 20a and 20b are operated as the cathode 12 and either grids 22a and 22b in the embodiment of FIG. 3a or apertures 28a and 28b in FIG. 3b are operated as the anodes 14. Resistive ballasting of the cathodes 12 is required to ignite a discharge simultaneously in all tubes 20a and 20b comprising the array.

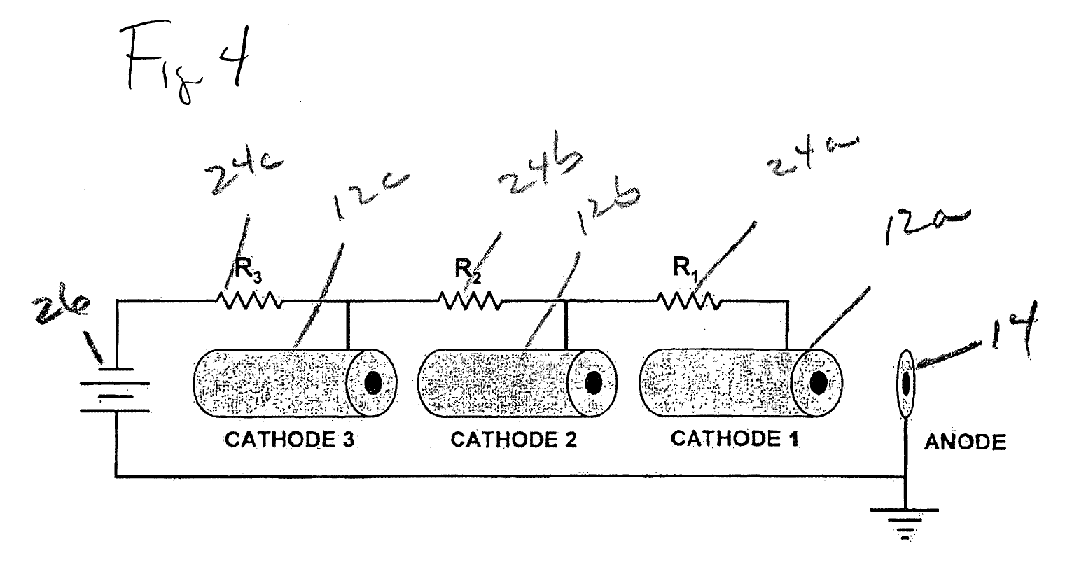

The schemes shown in FIGS. 3a and 3b increase the discharge length and, thus, increase the light output by adding plasma current while keeping the plasma voltage the same in each discharge stage 12, 14 (20a, 28a; and 20b, 28b). It is also possible to increase the plasma volume by adding plasma voltage through a breakdown scheme such as the one depicted in FIG. 4, which diagrammatically shows multiple discharges in metal capillary tubes 12a, 12b, and 12c placed in series with single anode 14 and multiple cathode arrangement. Tubes 12a, 12b, and 12c are all stainless steel capillary tubes (0.0625″).D., 0.007″ I.D., 4 mm length). Resistors 24a, 24b and 24c are chosen such that R₃ [symbol] R₂, and R₃ [symbol] R₁. In this embodiment discharges are ignited sequentially one at a time. Initial breakdown occurs between cathode 12a and anode 14 as in a single tube embodiment. Breakdown between cathode 12a and cathode 12b is achieved by further increasing the power supply voltage. The resistor 24a between cathodes 12a and 12b allows the voltage on cathode 12b to exceed the plasma voltage, allowing for breakdown to occur. This can be repeated for the third cathode 12c and extended to any number of tubes with each tube in the array having n times the plasma voltage.

Stacking, alignment and simultaneous operation of multiple capillary microdischarges 10 is proposed as a method to increase the plasma volume and thus the optical intensity of excimer radiation. When a sufficient discharge length is reached, lasing may ensue upon continuous wave (CW) or pulsed operation leading to an excimer microlaser.

Many alterations and modifications may be made by those having ordinary skill in the art without departing from the spirit and scope of the invention. For example,

Therefore, it must be understood that the illustrated embodiment has been set forth only for the purposes of example and that it should not be taken as limiting the invention as defined by the following claims. For example, notwithstanding the fact that the elements of a claim are set forth below in a certain combination, it must be expressly understood that the invention includes other combinations of fewer, more or different elements, which are disclosed in above even when not initially claimed in such combinations.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptionally equivalent, what can be obviously substituted and also what essentially incorporates the essential idea of the invention.

1. An apparatus for providing excimer radiation comprising a plurality of microdischarge stages, each stage comprising a cathode element and anode-like element through which elements a selected gas flows, each of the microdischarge stages of the plurality being serially communicated with each other such that the gas flows in succession through each stage of the plurality, and a power supply coupled to each stage for providing a correspondingly selected plasma voltage to each stage.

2. The apparatus of claim 1 where the plurality of microdischarge stages comprises an alternating planar array of metal and insulating layers through which a common plasma cavity is defined for the flow of gas, the metal layers being coupled to the power supply and configured as an alternating sequence of cathodes and anodes.

3. The apparatus of claim 2 where the alternating sequence of cathodes and anodes are configured to provide an initial cathode and a final cathode in the sequence at the ends of the plurality of microdischarge stages.

4. The apparatus of claim 2 where the alternating sequence of cathodes and anodes are configured to provide an initial anode and a final anode in the sequence at the ends of the plurality of microdischarge stages.

5. The apparatus of claim 1 where the plurality of microdischarge stages comprises an alternating sequence of cathode tubes and anodes.

6. The apparatus of claim 5 further comprising a resistance ladder having a plurality of nodes coupled to the power supply and at selected nodes of the resistance ladder to the sequence of cathode tubes.

7. The apparatus of claim 5 where the plurality of microdischarge stages comprises an alternating sequence of cathode tubes and anode grids.

8. The apparatus of claim 5 where the plurality of microdischarge stages comprises an alternating sequence of cathode tubes and anode apertures.

9. The apparatus of claim 1 where the plurality of microdischarge stages comprises a sequence of cathode tubes and a single terminating anode at the end of the sequence of cathode tubes, each cathode tube downstream in the sequence as defined by the flow of gas serving as the anode for the cathode tube upstream in the sequence.

10. The apparatus of claim 6 where the plurality of microdischarge stages comprises an alternating sequence of cathode tubes and anode grids.

11. The apparatus of claim 6 where the plurality of microdischarge stages comprises an alternating sequence of cathode tubes and anode apertures.

12. The apparatus of claim 1 where the plurality of microdischarge stages comprises a sequence of cathode tubes and a single terminating anode at the end of the sequence of cathode tubes, each cathode tube downstream in the sequence as defined by the flow of gas serving as the anode for the cathode tube upstream in the sequence and further comprising a resistance ladder having a plurality of nodes coupled to the power supply and at selected nodes of the resistance ladder to the sequence of cathode tubes.

13. A method for providing excimer radiation comprising:
flowing a selected gas serially through a plurality of microdischarge stages, each stage comprising a cathode element and anode-like element through which elements the selected gas flows in succession; and
applying a voltage to each of the stages from a power supply to initiate or maintain an excimer plasma in each stage.

14. The method of claim 13 where flowing the selected gas serially through a plurality of microdischarge stages comprises flowing the selected gas through an alternating sequence of planar metal and insulating layers through which a common plasma cavity is defined.

15. The method of claim 14 where flowing the selected gas through an alternating sequence of planar metal and insulating layers comprises flowing the gas through an initial cathode and a final cathode in the sequence at the ends of the plurality of microdischarge stages.

16. The method of claim 14 where flowing the selected gas through an alternating sequence of planar metal and insulating layers comprises flowing the gas through an initial anode and a final anode in the sequence at the ends of the plurality of microdischarge stages.

17. The method of claim 13 where flowing the selected gas serially through a plurality of microdischarge stages comprises flowing the gas through an alternating sequence of cathode tubes and anodes.

18. The method of claim 17 where flowing the gas through an alternating sequence of cathode tubes and anodes comprises flowing the gas through an alternating sequence of cathode tubes and anode grids.

19. The method of claim 17 where flowing the gas through an alternating sequence of cathode tubes and anodes comprises flowing the gas through an alternating sequence of cathode tubes and anode apertures.

20. The method of claim 13 where flowing the selected gas serially through a plurality of microdischarge stages comprises flowing the gas through a sequence of cathode tubes and a single terminating anode at the end of the sequence of cathode tubes, each cathode tube downstream in the sequence as defined by the flow of gas serving as the anode for the cathode tube upstream in the sequence.

21. The method of claim 13 where flowing the selected gas serially through a plurality of microdischarge stages comprises flowing the gas through a sequence of cathode tubes and a single terminating anode at the end of the sequence of cathode tubes, each cathode tube downstream in the sequence as defined by the flow of gas serving as the anode for the cathode tube upstream in the sequence, and where applying a voltage to each of the stages from a power supply to initiate or maintain an excimer plasma in each stage comprises coupling a resistance ladder having a plurality of nodes coupled to the power supply and coupling selected nodes of the resistance ladder to the sequence of cathode tubes.

22. The method of claim 13 further comprising employing the excimer plasma in a microlaser.
